(19) United States
(12) Patent Application Publication
(10) Pub. No.: US 2012/0140247 A1
(43) Pub. Date: Jun. 7, 2012

(54) METHODS AND APPARATUS FOR DETERMINING DEFLECTION OF AN EQUIPMENT FOUNDATION

(75) Inventor: Charles J. MONESTERE, Delmar, NY (US)

(73) Assignee: MECHANICAL DYNAMICS & ANALYSIS, LTD., Latham, NY (US)

(21) Appl. No.: 12/960,817

(22) Filed: Dec. 6, 2010

(51) Int. Cl. G01B 11/14

(52) U.S. Cl. 356/620

(57) ABSTRACT

Methods and apparatus for determining deflection of an equipment foundation, for example, a steam turbine foundation, are disclosed. The apparatus includes a laser beam source positioned to direct a laser beam above a surface of the foundation to be monitored, a plurality of targets positioned above the surface of the foundation, a detector adapted to detect a position of each if the targets relative to a position of the laser beam; and a device for comparing the detected position of each of the targets with a predetermined position to determine changes in the position to determine deflection of the foundation. Methods and various targets for implementing the invention are also disclosed.

### BACKGROUND OF THE INVENTION

1. Field of the Invention

The present invention relates, generally, to methods and apparatus for determining the deflection of foundations used to support large equipment, particularly, to methods and apparatus for determining the deflection of foundations of turbine-generators to estimate any variation in alignment of turbine-generator components.

2. Description of Related Art

Large equipment, in particular, large equipment having rotating components, such as, steam turbine-generators, are often installed on large foundations, for example, large steel reinforced concrete foundations. These foundations may be as long as 200 feet in some of the largest installations. These foundations are designed to provide a high level of support with minimal deflection throughout the life of the equipment being supported. In the case of steam turbine-generators, the equipment life expectancy is normally between about 20 and about 50 years, with some units remaining in service for even longer periods. Typically, the larger the foundation, the more likely there will be foundation settling problems that affect equipment operation, for example, turbine alignment.

Though typically very rigid, even these large foundations are subject to deflection, for example, deflection from the position of the foundation from its initial position upon construction and installation of the equipment being supported, for example, due to building or foundation settling or even seismic activity. The magnitude of the deflection can vary dramatically, and can be imperceptible to the naked eye; however, even slight deflections can impact the equipment mounted on the foundation, for example, foundation deflection can effect bearing alignment and other alignments in rotating machinery that can damage the equipment and its proper operation. For instance, component misalignment can cause undesirable vibrations.

Steam turbines and other large pieces of rotating equipment include both stationary and rotating components. Typically, these components must be precisely aligned with respect to each other in order to ensure proper operation, for example, to prevent the rotating components from rubbing against the stationary components. A well designed and constructed foundation will normally provide the equipment support required to maintain the component alignments for the life of the unit. Some large foundations may fail to provide the stable base required for proper equipment operation, and operational problems may become apparent. When foundations are not rigid, for example, when they move over time, the relationship between the various components changes and the machine may not operate smoothly, and in sever cases, equipment failure can occur.

The monitoring of foundation settlement or displacement has historically been very difficult. In addition, foundation displacement is often only checked through alignment checks made on the rotating equipment during major maintenance overhauls. Maintenance intervals vary, but these checks are most often performed every 5 to 10 years. Since equipment operational problems (such as, high vibration or high/low bearing metal temperatures) may be a result of misalignment due to improper foundation support, having the ability to check for foundation settlement without removing the equipment from service may be extremely valuable when trouble shooting operational problems. Moreover, there may often be other unrelated causes for operational problems which may have similar symptoms as those that result from foundation displacement issues. If foundation settlement is found, the components can be re-aligned and the equipment returned to service.

Prior art methods and devices for monitoring foundation displacement typically include the use of structures or “monuments” embedded in the foundation surface that are used to monitor foundation movement. The elevations of these monuments are typically measured and monitored or recorded over time using an optical level or other precision measuring device, such as, a laser tracker. However, among other disadvantages, the monitoring of embedded monuments is limited to monitoring of vertical displacement of the foundation.

In the field of steam turbine manufacture and maintenance, laser alignment methods are sometimes used to check or adjust the alignment of internal rotating components. Aspects of the present invention were developed based upon such laser-assisted alignment methods for internal rotating components. However, aspects of the present invention apply to the monitoring of foundation deflection, and have unique aspects that distinguish from existing internal component alignment methods.

Hence, there is a need in the art to facilitate the detection of foundation deflection, for example, vertical and/or horizontal deflection of equipment foundations. Aspects of the present invention provide methods and apparatus for monitoring and/or detecting foundation deflection. For example, aspects of the invention provide equipment foundation vertical and horizontal displacement measurements that can be provided without removing the equipment from service. Aspects of the invention can provide equipment suppliers and owners a fast, effective, and accurate method of monitoring changes to their equipment support system. Accordingly, aspects of the invention can allow for the monitoring of the foundation condition more regularly, and studies can be performed to better evaluate and understand the various operating conditions that may influence deflections in equipment foundations.

### SUMMARY OF ASPECTS OF THE INVENTION

Embodiments of the present invention allow technicians to monitor deflection of the foundations that support large pieces of equipment during installation, maintenance, and/or over time. Though aspects of the invention are adapted for use with rotating equipment, such as, large turbine-generators, aspects of the invention may be used to monitor the deflection of any foundation or structure.

One embodiment of the present invention is a method for determining deflection of an equipment foundation, the method comprising or including positioning at least one target above a surface of a foundation, the at least one target coupled to the foundation, the at least one target located at a location on the foundation, and the at least one target having a target feature; directing a beam of electromagnetic radiation, for example, a laser beam, above the surface of the foundation to be monitored wherein the beam passes in the vicinity of the target feature of the at least one target; detecting a position of the target feature of the at least one target relative to a position of the beam of electromagnetic radiation at the location of the at least one target; and comparing the detected position with a predetermined position of the target feature to determine a deflection of the foundation at the location of the at least one target. In one aspect, positioning at least one target comprises positioning a plurality of targets above the surface of the foundation, each of the plurality of targets located at a location on the foundation and each of the targets having a target feature in a vicinity of the beam of electromagnetic radiation at the location on the foundation. In one aspect, the target comprises a circular bore and the target feature comprises a centerline of the circular bore. In another aspect, the target comprises a plurality surfaces and the target feature comprises at least one, but typically two, of the plurality of surfaces of the target.

Another embodiment of the invention is an apparatus for determining deflection of an equipment foundation, the apparatus comprising or including an electromagnetic radiation source, for example, a laser source, positioned to direct a beam of electromagnetic radiation above a surface of a foundation to be monitored; at least one target positioned above the surface of the foundation, the at least one target located at a location on the foundation and having a target feature positioned in a vicinity of the beam of electromagnetic radiation at the location; a detector adapted to detect a position of the target feature of the target relative to a position of the beam of electromagnetic radiation at the location; and means for comparing the detected position with a predetermined position to determine a deflection of the foundation at the location. In one aspect, the at least one target comprises a plurality of targets positioned above the surface of the foundation, each of the plurality of targets located at a location on the foundation and each of the targets having a target feature in a vicinity of the beam of electromagnetic radiation at the location on the foundation. In another aspect, the target comprises a circular bore and the target feature comprises a centerline of the circular bore. In another aspect, the target comprises a plurality surfaces and the target feature comprises at least one, but typically two, of the plurality of surfaces of the target. In one aspect, the detector comprises a detector mounted on a target adapter mountable to the target wherein the detector is positioned to detect the beam.

A further aspect of the invention is an apparatus for determining deflection of a turbine foundation, the apparatus comprising or including a laser beam source positioned to direct a laser beam above a surface of the turbine foundation to be monitored; a plurality of targets positioned above the surface of the foundation, each of the plurality of targets located at a location on the foundation and having a target feature positioned in a vicinity of the position of the laser beam at the location; a detector adapted to detect a position of the target feature of each of the plurality of targets relative to a position of the laser beam at the location; and means for comparing the detected position of each of the target features of each of the targets with a predetermined position of the target features at the location of each of the targets to determine changes in the position of each of the target features at each location to determine deflection of the foundation at each location. In one aspect, the apparatus further comprises a laser detector positioned to detect the laser beam emitted from the laser source. In another aspect, the apparatus further comprises a plurality of foundation plates mounted to the surface of the foundation, each of the plurality of foundation plates adapted to receive one of the plurality of targets.

In one aspect, each of the plurality of targets comprises a circular bore, wherein the target feature of each of the plurality of targets comprises a centerline of the circular bore, and wherein the detector comprises a detector mounted on a target adapter mountable in the circular bore of each of the plurality of the targets wherein the detector is positioned to detect the beam. In another aspect, each of the plurality of targets comprises a body having a first surface and a second surface substantially perpendicular to the first surface, and wherein the target feature of each of the plurality of targets comprises the first surface and the second surface, and wherein the detector comprises a detector mounted on a target adapter selectively mountable on one of the first surface and the second surface of each of the plurality of the targets wherein the detector is positioned to detect the beam.

Details of these aspects of the invention, as well as further aspects of the invention, will become more readily apparent upon review of the following drawings and the accompanying claims.

### BRIEF DESCRIPTIONS OF THE FIGURES

The subject matter that is regarded as the invention is particularly pointed out and distinctly claimed in the claims at the conclusion of the specification. The foregoing embodiments and aspects, and other objects, features, and advantages of the invention, will be readily understood from the following detailed description of aspects of the invention taken in conjunction with the accompanying drawings in which:

FIG. 1 is a schematic perspective view of a system having a piece of equipment mounted on a foundation having one aspect of the present invention for monitoring deflection of the foundation.

FIG. 2 is a schematic elevation view of the aspect of the invention shown in FIG. 1.

FIG. 3 is an elevation view of the aspect of the invention shown in FIG. 2 as viewed along section lines 3-3 in FIG. 2.

FIG. 4 is a schematic perspective view of another system having a piece of equipment mounted on a foundation having another aspect of the present invention for monitoring deflection of the foundation.

FIG. 5 is a schematic perspective view of the aspect of the present invention shown in FIG. 4.

FIG. 6 is a schematic perspective view of a target and laser detector shown in FIG. 5 according to an aspect of the invention.

FIG. 7 is a schematic perspective view of a target and laser detector shown in FIG. 5 according to another aspect of the invention.

FIG. 8 is a schematic perspective view similar to FIG. 7 with the laser detector rotated 90 degrees from the orientation of the laser detector shown in FIG. 7.

FIG. 9 is an exploded perspective view of the aspect shown in FIG. 7.

### DETAILED DESCRIPTION OF THE FIGURES

The details and scope of the aspects of the present invention can best be understood upon review of the attached figures and their following descriptions.

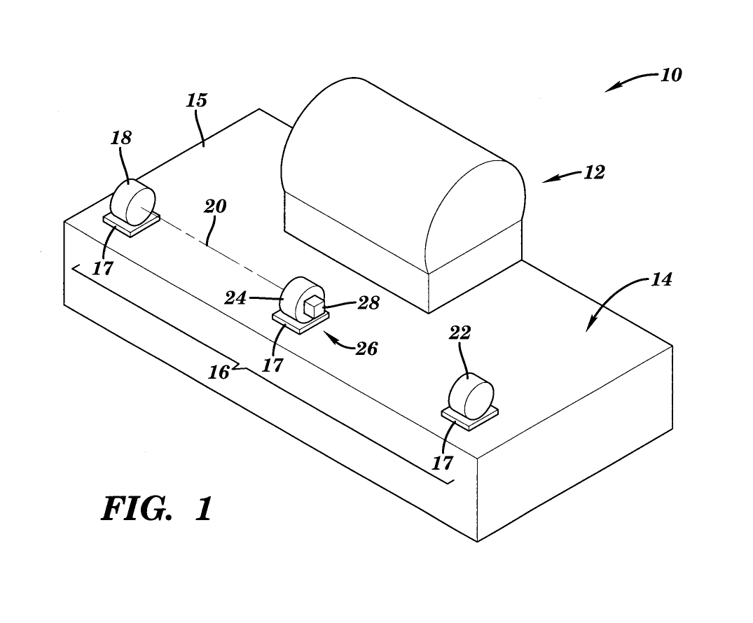

FIG. 1 is a schematic perspective view of system 10 having a piece of equipment 12, for example, a section of turbine generator, such as, a high pressure (HP) section or an intermediate pressure (IP) section of a turbine, mounted on a foundation 14 having an apparatus 16 for monitoring the deflection of the foundation 14 according to one aspect of the invention. In the aspect of the invention shown, apparatus 16 includes an electromagnetic radiation source 18 positioned to direct a beam of electromagnetic radiation 20, for example, a laser beam, above a surface 15 of foundation 14 to be monitored; an electromagnetic radiation detector 22 positioned to detect the beam of electromagnetic radiation 20 from the source 18; at least one target 24 positioned above the surface 15 of foundation 14, the at least one target 24 located at a location 26 on the foundation 14 and having a target feature (not shown, but see FIG. 3 and the discussion below) positioned in a vicinity of the beam of electromagnetic radiation 20 at the location 26; a detector 28 adapted to detect a position of the target feature of the target 24 relative to a position of the beam of electromagnetic radiation 20 at the location 26; and means (not shown) for comparing the detected position with a predetermined position to determine a defection of the foundation at the location. As shown in FIG. 1, source 20, detector 22, and target 24 may be mounted to foundation plates 17 mounted to surface 15 of foundation 14, for example, foundation plates 17 may be metallic plates fixed to surface 15, for instance by mechanical fasteners and/or grout.

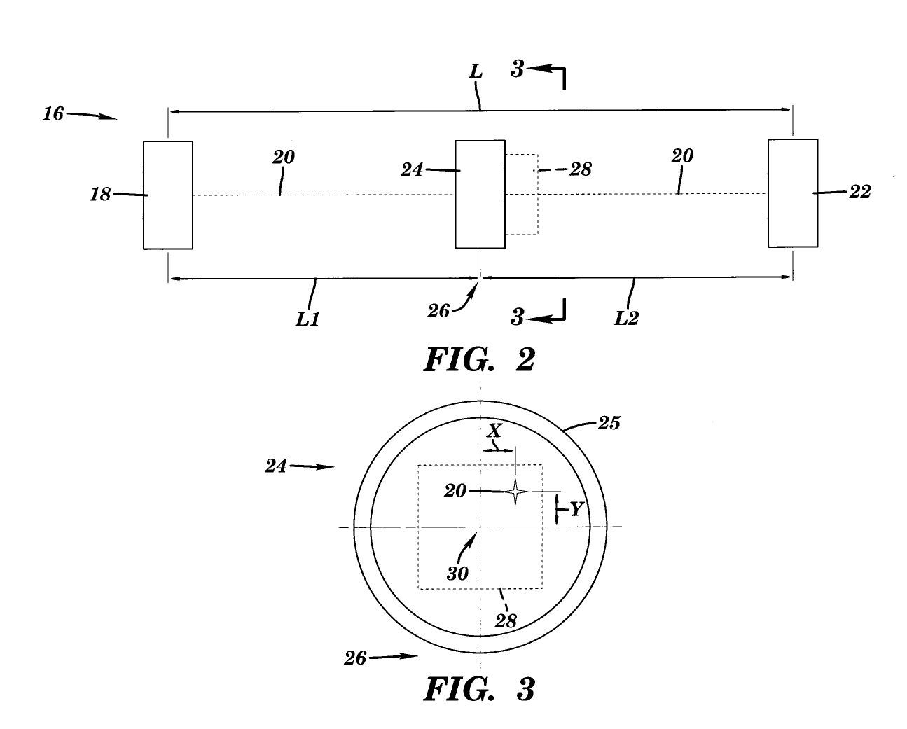

FIG. 2 is a schematic elevation view of the apparatus 16 having electromagnetic radiation source 18, beam 20, detector 22, and target 24 shown in FIG. 1, and FIG. 3 is an elevation view of apparatus 16 shown in FIG. 2 as viewed along section lines 3-3 in FIG. 2. Detector 28 is shown in phantom in FIGS. 2 and 3. As shown in FIG. 3, target 24 includes a target feature 30 positioned to be located relative to beam 20. According to aspects of the invention, target feature 30 may be any feature of target 24, for example, a surface, a projection, a recess, a hole, and a dimension, among others, that can be located relative to the position of beam 20 at the location 26 of target 24. In the aspect of the invention shown in FIG. 3, target 24 comprises a circle or cylinder 25 and target feature 30 is the center of circle 25 or the centerline of cylinder 25.

According to aspects of the invention, detector 28 (shown in phantom) is adapted to detect the relative position of target feature 30 to the position of beam 20 at the location 26 of target 24. As shown in FIG. 3, this may typically be a horizontal distance X, vertical distance Y, or both a horizontal distance X and a vertical distance Y. (In the aspect of the invention shown in FIG. 3, and throughout this disclosure, the distance between a target feature and beam 20, for example, distances X and Y, is exaggerated in order to facilitate illustration of aspects of the invention.) Since target 24 and target feature 30 are rigidly mounted to surface 15 at location 26, any deflection of target feature 30, for example, horizontally or vertically, corresponds to the deflection of surface 15 at or about location 26. It should be understood that aspects of the present invention are not limited to determining the relative position of target feature 26 with respect to beam 20 in terms of Cartesian coordinates, other coordinate systems, such as, polar coordinates (R, θ), may also be used, among others.

In the following discussion, electromagnetic radiation beam 20, and other references to an electromagnetic radiation beam in this disclosure, will be referred to as “a laser” in order to facilitate the following descriptions of aspects of the invention. However, according to aspects of the invention laser 20 may comprise any beam of electromagnetic radiation that is applicable for use with aspects of the invention, including microwaves, terahertz waves, infrared light, visible light, ultraviolet light, x-rays, gamma rays, and radio waves.

As shown in FIGS. 2 and 3, according to aspects of the invention, the relative location of source 18, detector 22, target 24, and/or target feature 30 may be used to establish and monitor the deflection of surface 15 at and around the location 26 of target 24. For example, the location of source 18, the location of detector 22, and/or laser 20 establishes a datum in three-dimensional space by which the location of target feature 30 may be determined by detector 28. According to one aspect of the invention, detector 28 is mounted to target 24 wherein the position of target feature 30 is associated with detector 28. For example, as will be discussed below, in one aspect, the position of laser 20 at location 26 of target 24 detected by detector 28 is referenced to target feature 30 of target 24.

In one aspect of the invention, the relative deflection of surface 15 of foundation 14 between source 18 and detector 22 can be interpolated from the deflection of surface 15 at location 26. For example, as shown in FIG. 2, in one aspect, the locations of source 18 and detector 22 defines a baseline distance L between source 18 and detector 22. Location 26 of target 24 establishes target distance L1 or L2 from source 18 and detector 22. Therefore, by determining a deflection of surface 15 at location 26, the deflection at location 26 can be used to interpolate by triangulation a relative deflection of surface 15 between source 18 and target 24 and between target 24 and detector 22.

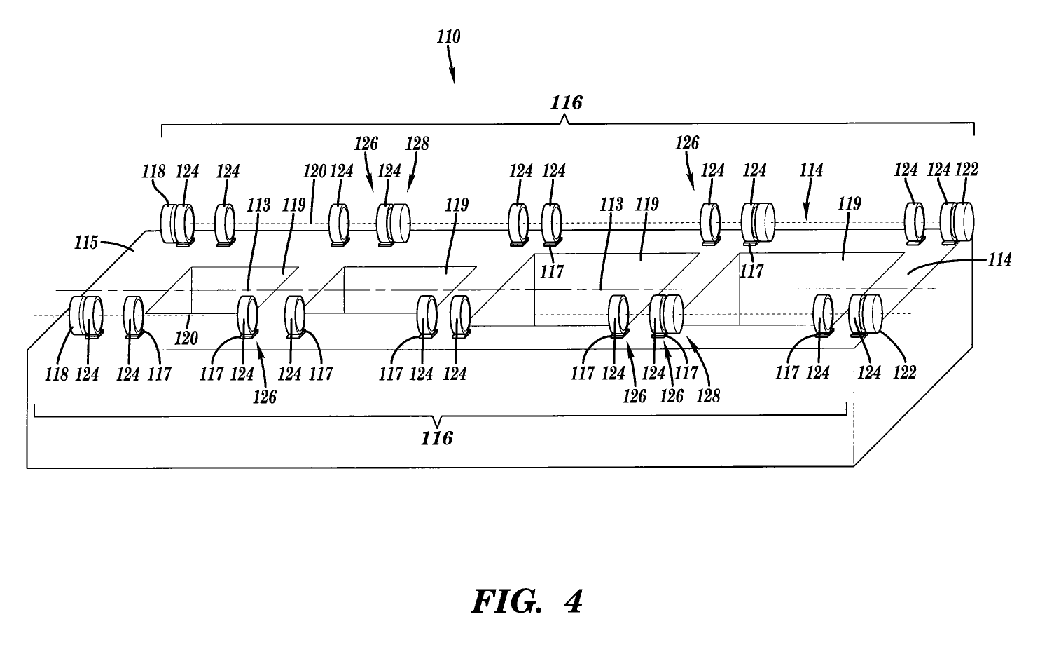

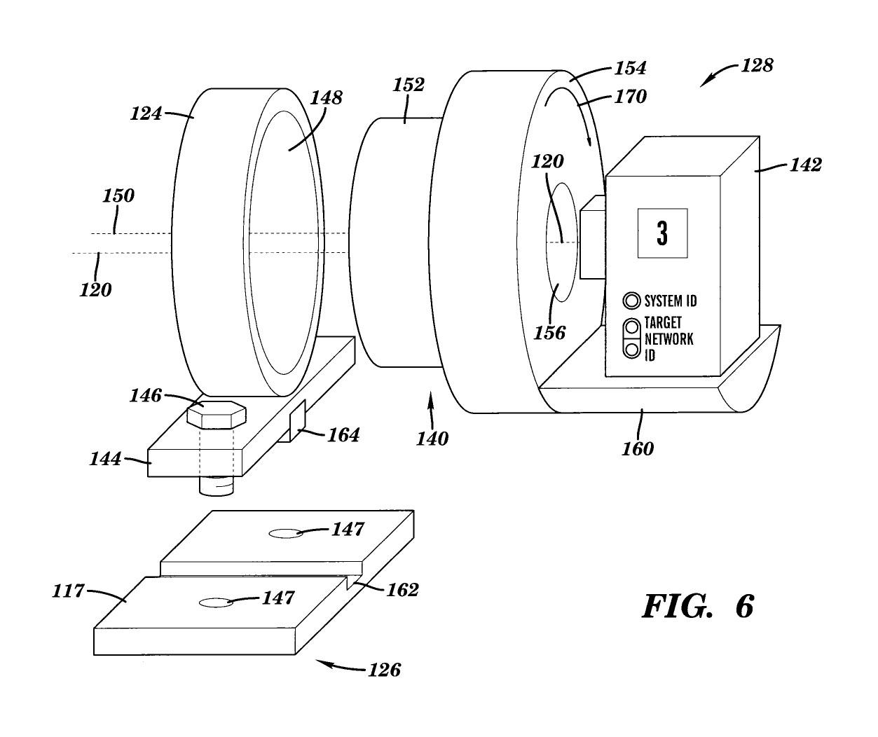

FIG. 4 is a schematic perspective view of a system 110 having a piece of equipment (not shown), for example, a turbine, mounted on a foundation 114 having apparatus 116 for monitoring or detecting deflections of foundation 114 according to another aspect of the present invention. Though the equipment is not shown in FIG. 4, foundation 114 includes four cavities or openings 119 typically provided to accommodate four sections of a four-section steam turbine. The equipment mounted on foundation 114 may typically have a centerline 113, for example, an axis of rotation of the rotating components of the equipment. As shown in FIG. 4, this aspect of the invention includes two apparatus 116 each having an electromagnetic radiation source, or laser, 118 positioned to direct a beam of electromagnetic radiation 120, for example, a laser beam, above a surface 115 of foundation 114 to be monitored; an electromagnetic radiation detector 122 positioned to detect the beam of electromagnetic radiation 120 from the source 118; a plurality of targets 124 positioned above the surface 115 of foundation 114, the at least one target 124 located at a location 126 on the foundation 14 and having a target feature (not shown, but shown in FIG. 6) positioned in a vicinity of the beam of electromagnetic radiation 120 at the location 126; a detector 128 adapted to detect a position of the target feature of the target 124 relative to a position of the beam of electromagnetic radiation 120 at the location 126; and means (not shown) for comparing the detected position with a predetermined position to determine a deflection of the foundation at the location. As shown in FIG. 4, source 120, detector 122, and target 124 may be mounted to foundation plates 117 mounted to surface 115 of foundation 114, for example, foundation plates 117 may be metallic plates fixed, for example, substantially permanently fixed, to surface 115, for instance, by mechanical fasteners and/or grout.

As also shown in FIG. 4, in one aspect, apparatus 116 (and apparatus 16 disclosed above) include a target feature detector 128. According to an aspect of the invention, target feature detector 128 is adapted to determine the distance of a target feature (not shown, for example, target feature 30 shown in FIG. 3) from laser beam 120, for example, a horizontal distance, a vertical distance, or both, at the position 126 of a target 124. Details of target feature detector 128 are provided below with respect to FIGS. 6-9.

In the aspect of the invention shown in FIG. 4, two apparatus 116 having a plurality of targets 124 are provided. In one aspect, one or more apparatus 116 may be provided. As shown in FIG. 4, the two apparatus 116 are positioned on either side of the equipment (not shown) mounted on foundation 114. In the aspect shown, each apparatus 116 include ten (10) targets 124, though according to aspects of the invention two or more targets may be provided. The number of targets 124 and the location 126 of each of the targets 124 on foundation 114 may vary as a function of the size and type of equipment and foundation being monitored. As shown in FIG. 4, targets 124 may be generally aligned on the surface 115 of foundation 114, for example, generally aligned in a direction substantially parallel to the direction of centerline 113 of the equipment. In other aspects of the invention, targets 124 may be oriented from one side of the equipment to the opposite side of the equipment, for example, in a direction substantially perpendicular to centerline 113. In other aspects of the invention, targets 124 may also be mounted obliquely to the direction of centerline 113, for example, at any orientation that is accommodated by the equipment and the foundation 114 being monitored.

According to aspects of the invention, targets 124 are aligned within a predetermined distance of the axis of laser beam 120, for example, in one aspect of the invention, targets 124 may be aligned so that a technician can observe a line of sight along targets 124, for instance, a line of sight through an aperture or opening in targets 124. In one aspect, targets 124 may be positioned on surface 115 of foundation 114 adjacent to bearing support points of the equipment mounted on foundation 114. Since the bearings may typically provide the principle means of supporting the rotating equipment mounted on foundation 114, determining the deflection of the foundation 114 at or adjacent to the bearing support points, for example, at or adjacent to the bearing housings, can provide information on the equipment position and the relative alignment of the equipment, especially, the alignment of rotating components, such as, turbine blade shafts.

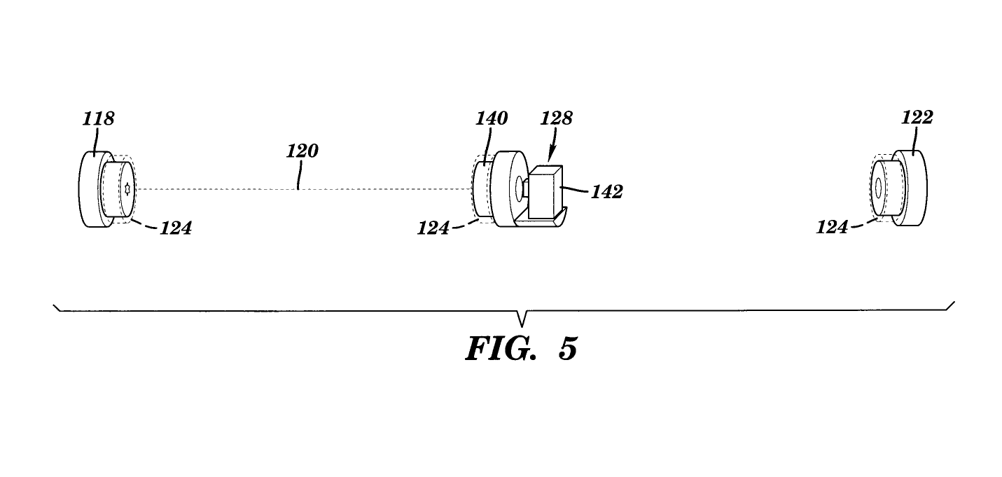

FIG. 5 is a schematic perspective view of apparatus 116 shown in FIG. 4 according to one aspect of the invention. As shown, though apparatus 116 may include 2 or more targets 124, for example, 4 or more targets 124, or the ten targets 124 shown in FIG. 4, for the sake of illustration, apparatus 116 shown in FIG. 5 includes only three targets 124 shown in phantom. Apparatus 116 shown in FIG. 5 includes laser source 118, detector 128, and detector 122. As also shown in FIG. 5, targets 124 may provide a support structure for laser source 118, detector 128, and detector 122 and retain the source 118, detector 128 and detector 122 above the surface 115 of foundation 114. According to aspects of the invention, as shown in FIG. 5, laser beam 120 directed by laser source 118 is detected by detector 128 to determine the location of a target feature (not shown) of target 124 to which detector 128 is mounted. As shown in FIG. 5, according to one aspect of the invention, detector 128 may include target adapter 140 and a laser sensor 142 mounted to target adapter 140. One target adapter 140 and one laser detector 142 that may be used for aspects of the invention are shown in FIG. 6.

Laser source 118 in FIGS. 4 and 5 may be any laser source adapted to provide laser beam 120. For example, in one aspect, laser source 118 may be a L705 or L706 laser source provided by Hamar Laser of Danbury, Conn., though other equivalent sources may be used. Laser source 118 may be mounted in a target 124, or other structure, to provide laser beam 120. As shown in FIG. 5 laser source 118 may be mounted in a housing or adapter that is adapted to engage a target 124. For example, laser source 118 may be mounted in a housing adapted to engage the bore 148 (see below) of target 124 in a fashion similar to the engagement of target adapter 140 with bore 148 shown in FIG. 6.

Laser detector 122 may be any laser sensor adapted to detect laser beam 120. For example, in one aspect, laser sensor 122 may be a T-218T laser sensor provided by Hamar Laser, though other equivalent sensors may be used. Laser detector 122 may also be mounted in a target 124, or other structure, to detect laser beam 120. As shown in FIG. 5 laser detector 122 may also be mounted in a housing that is adapted to engage a target 124. For example, laser detector 122 may be mounted in a housing adapted to engage the bore 148 of target 124 in a fashion similar to the engagement of target adapter 140 with bore 148 shown in FIG. 6.

The means for comparing the detected position with a predetermined position to determine a deflection of the foundation 114 at the location 126 may be conventional. For example, the means may comprise a technician manually detecting and/or recording the detected position and manually or mentally calculating any change in the location of target feature 30 or recording the detected position for later comparison to one or more previously recorded target feature positions. The means for comparing the detected position with a predetermined position may also be automated means, for example, employing an arithmetic processor, such as, a data acquisition system, personal computer, laptop, or palm-size device. In one aspect, detector 28, 128 may have storage and processor capability where the comparison may be practiced by laser detector 28, 128. The results of the comparison may be stored for immediate or future retrieval, for example, on one of the devices mentioned above or on a display or printer. In one aspect, the detector 28, 128 may communicate by wire or wirelessly with a remote receiver having data storage, data processing, and/or data output capabilities, for example, via local or wide area wireless network. The means for comparing may also include a means for communicating with a remote receiver, for example, over the Internet.

FIG. 6 is an exploded perspective view of target 124 and detector 128 mounted to a foundation plate 117 according to one aspect of the invention. As noted, above, foundation plate 117 may typically be mounted to surface 115 of foundation 114 (not shown), for example, substantially permanently mounted by mechanical fasteners and/or grout (not shown). As also shown in FIG. 6, target 124 may be adapted to mount to foundation plate 117, for example, removably mount to foundation plate 117. For example, target 124 may include a mounting plate 144 adapted to mount to foundation plate 117, for instance, mounting plate 144 may include one or more threaded or through holes adapted to receive one or more fasteners 146, for example, hex had cap screws, that are received by threaded holes 147 in foundation plate 117, though other fasteners may be used.

In the aspect of the invention shown in invention in FIG. 6, target 124 comprises an internal circular bore 148 having a bore centerline 150. According to aspects of the invention target 124 may assume any shape, for example, rectangular or square cylindrical shape, while providing internal circular bore 148. In the aspect shown, target 124 comprises a right circular cylinder having axially directed bore 148. In this aspect of the invention, the centerline 150 of bore 148 is the target feature of target 124.

According to this aspect, detector 128 includes a target adapter 140 and a laser sensor 142 mounted to target adapter 140. In the aspect shown, target adapter 140 comprises an external circular boss 152 sized to be received by internal bore 148 of target 124, a flange 154, and an axially extending through hole or bore 156. Laser sensor 142 may be mounted to target adapter 140 in such a way that laser beam 120 passing through target 124 and bore 156 of target adapter 140 is detectable by laser sensor 142. Though laser sensor 142 may be mounted in any conventional fashion to target adapter 140, in the aspect of the invention shown in FIG. 6, target adapter 140 includes a projection or shelf 160 positioned and adapted to receive laser sensor 142, for example, by one or more mechanical fasteners (not shown). For example, shelf 160 may include one or more through holes or threaded holes (not shown) adapted to receive fasteners for mounting laser sensor 142 to shelf 160. Other conventional means of mounting laser sensor 142 to target adapter 140 may be used and are considered within the scope of the present invention.

Laser sensor 142 may be any laser sensor adapted to detect laser beam 120. For example, in one aspect, laser sensor 142 may be an A-1519 laser sensor provided by Hamar Laser, though other equivalent sensors may be used.

According to the aspect of the invention shown in FIG. 6, the dimension of the outside diameter of boss 152 of target adapter 140 is closely toleranced to the dimension of the inside diameter of bore 148 of target 124. For example, the outside diameter of boss 152 may have a machined dimension of (D−0.001)+0.0005/−0.0000, where D is a nominal diameter of boss 152, and the inside diameter of bore 148 may have a machined dimension D+0.0005/−0.0000. For instance, in one aspect of the invention, the outside diameter of boss 152 may have a nominal diameter, D, of 2 inches and a machined dimension of 1.999 inches+0.0005/−0.0000 inches and the inside diameter of bore 148 may have a machined dimension of 2.000 inches+0.0005/−0.0000 inches. Since laser sensor 142 may be mounted in a predetermined position on target adapter 140, for example, on shelf 160, the relative position of the centerline of boss 152 of target adapter 140 and the position of the sensor of laser sensor 142 may be predetermined. Accordingly, according to aspects of the invention, due to the close tolerancing of boss 152 and bore 148, when boss 152 is inserted into bore 148 the centerline of boss 152 corresponds to the position of centerline 150 of bore 148. When the position of laser beam 120 is detected by laser sensor 142, since the position of the sensor on laser sensor 142 to the position of the centerline of the outside diameter of boss 152 is predetermined, the location of centerline 150 of target 124 can be determined relative to the position of laser beam 120. (For example, see the similar relative position of laser beam 20 with respect to centerline 30 shown in FIG. 3.) In one aspect, the outside diameter of boss 152 may not be continuous, for example, boss 152 may have three or more points or surfaces of contact defining an outside diameter engageable with bore 148. Alternately, bore 148 may not be continuous, for example, bore 148 may have 3 or more points or surfaces of contact defining an inside diameter engageable with boss 152.

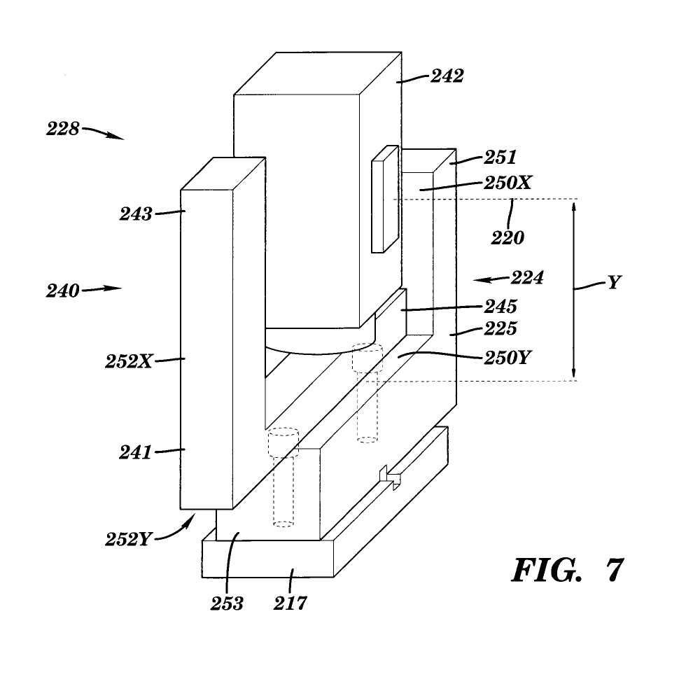

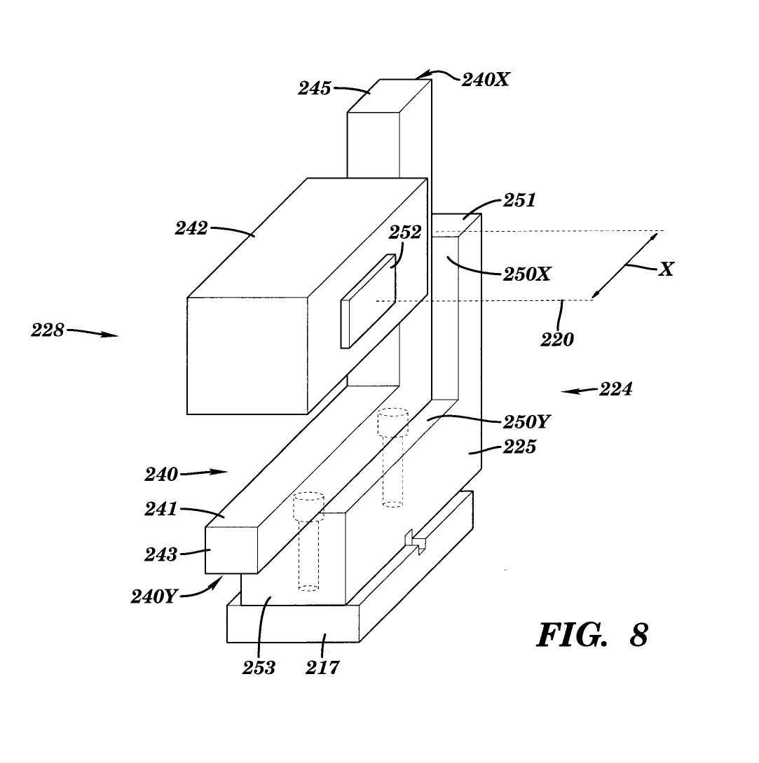

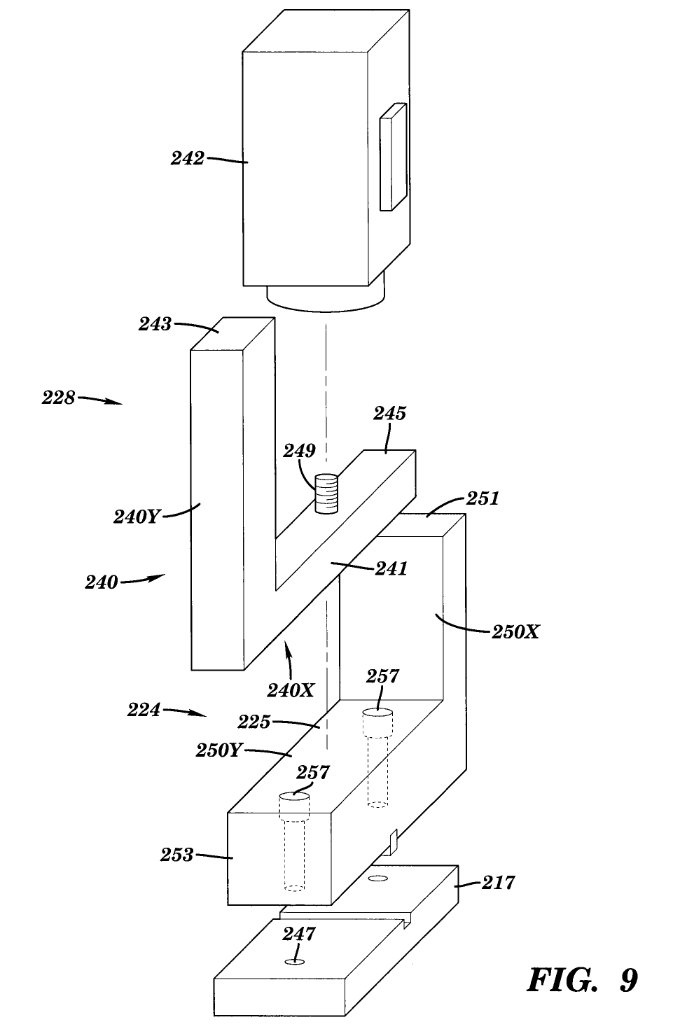

FIG. 7 is a schematic perspective view of another target 224 and laser detector 228 that may be used in apparatus 16, 116 according to another aspect of the invention. FIG. 8 is a schematic perspective view similar to FIG. 7 of the target 224 with the laser detector 228 rotated 90 degrees from the orientation of the laser detector 228 shown in FIG. 7. FIG. 9 is an exploded perspective view of target 224 shown in FIG. 7.

As shown in FIGS. 7-9, target 224 may provide a support structure for laser detector 228 (and may also provide a support for a laser source 18, 118 and detector 22, 122) above the surface (not shown) of a foundation (not shown). Target 224 may typically be mounted to a foundation plate 217 in a fashion similar to the mounting of foundation plates 17, 117 described below, including with unique mountings to unique foundation plates.

According to aspects of the invention, as shown in FIG. 7, laser beam 220 directed by laser source (note shown) is detected by detector 228 to determine the location of at least one target feature 250X, 250Y of target 224 to which detector 228 is mounted. In contrast to target 124 described above, target 224 comprises at least one target feature, but typically two target features 250X and 250Y comprising a surface 250X, for example, a vertical surface, and/or a surface 250Y, for example, a horizontal surface, respectively, of a body 225 of target 224. Though body 225 may take any three-dimensional shape while providing at least one surface 250X and/or one surface 250Y, in the aspect of the invention shown in FIGS. 7-9, body 225 comprises an “L shaped” body having two legs: leg 251 having surface 250X and leg 253 having surface 250Y.

As shown in FIGS. 7-9, according to one aspect of the invention, detector 228 may include a target adapter 240 and a laser sensor 242 mounted to target adapter 240. In the aspect shown, target adapter 240 comprises a body 241 adapted to receive laser sensor 242 and having at least one, but typically, at least two, surfaces 252X and 252Y adapted to bear against target features 250X and 250Y, respectively, of target 224. Though body 241 may also take any three-dimensional shape while providing at least one surface 252X and/or one surface 252Y, in the aspect of the invention shown in FIGS. 7-9, body 241 comprises an “L shaped” body having two legs: leg 243 having surface 252X and leg 245 having surface 252Y. One laser detector 142 that may be used for laser detector 242 is shown and described with respect to FIG. 6.

FIG. 9 is an exploded perspective view of detector 228 mounted to a foundation plate 217 according to one aspect of the invention. As noted above, foundation plate 217 may typically be mounted to surface 115 of foundation 114 (not shown), for example, substantially permanently mounted by mechanical fasteners and/or grout (not shown). As shown in FIG. 9, target 224 may be adapted to mount to foundation plate 217, for example, removably mounted to foundation plate 117. For instance, target 224 may include a mounting plate (not) adapted to mount to foundation plate 217, for instance, leg 253 of body 225 of target 224 may function as a mounting plate and may include one or more threaded or through holes 257 adapted to receive one or more fasteners (not shown), for example, hex had cap screws, that are received by threaded holes 247 in foundation plate 217, though other fasteners may be used.

According to this aspect shown in FIG. 9, detector 228 includes target adapter 240 and a laser sensor 242 mounted to target adapter 240. As shown in FIGS. 7-9, target adapter 240 comprises an L-shaped body 241 adapted to bear against surfaces, or target features, 250X and 250Y. Laser sensor 242 is mounted to target adapter 240 in such a way that laser beam 220 passing through or passed target 224 is detectable by laser sensor 242. Though laser sensor 242 may be mounted in any conventional fashion to target adapter 240, in the aspect of the invention shown in FIG. 9, laser sensor 242 is mounted by mechanical fasteners to leg 243 or 245 of body 241 of target adapter 240, for example, by means of a screw, bolt, or threaded stud 249. Other conventional means of mounting laser sensor 242 to target adapter 240 may be used and are considered within the scope of the present invention.

Laser sensor 242 may be any laser sensor adapted to detect laser beam 120, for example, laser sensor 142 described above may be used. In one aspect, laser sensor 242 may be an A-1519 laser sensor provided by Hamar Laser, though other equivalent sensors may be used.

According to the aspect of the invention shown in FIGS. 7-9, the surfaces, or target features, 250X and 250Y of body 241 of target 240 are positioned to provide reference data for the positioning of laser beam 220. For example, surfaces 250X and 250Y may be substantially perpendicular to each other, for instance, have a dimensional perpendicularity tolerance of 0.0005. In one aspect of the invention, surfaces 250X and 250Y may be adapted to receive laser sensor 242, for example, surfaces 250X and 250Y may include a stud or other fastener 249 for mounting laser sensor 242. In another aspect, laser sensor 242 may be held manually against surfaces 250X and 250Y to obtain a reading with laser 220.

However, in the aspect of the invention shown, in order to facilitate practicing aspects of the invention, target adapter 240 is provided to which sensor 242 is mounted, for example, removably mounted. Since laser sensor 242 may be mounted in a predetermined position on target adapter 240, for example, by stud 249, the relative positions of surfaces 240X and 240Y of body 241 of target adapter 240 with respect to the position of the sensor of laser sensor 242 may be predetermined. In addition, due to the precise dimensioning of surfaces 240X, 240Y, 250X, and 250Y, when target adapter 240 is placed on target 224, the relative position of the sensor of laser sensor 242 with respect to target surfaces 250X and 250Y may also be predetermined. Accordingly, according to aspects of the invention, when target adapter 240 is placed upon surface 250Y or 250Y of target 224, the relative distance to the sensor of laser sensor 242 from target features 250X and 250Y may be known. When the position of laser beam 220 is detected by laser sensor 242, the position of the sensor on laser sensor 242 to the position of the surfaces, or target features, 250X and 250Y can be determined relative to the position of laser beam 220. In this aspect of the invention, one or two distances or readings (X and/or Y) for one or more targets 224 may be obtained, for example, by positioning and then repositioning target sensor 228 on targets 224 as shown in FIGS. 7 and 8, and, typically, the readings may be recorded for future reference.

The components of targets 24, 124, 224 and detectors 28, 128, and 228 may made from metals or non-metals, for example, high performance plastics. However, it is preferred that the components be fabricated from metal, for example, iron, steel, stainless steel, titanium, or aluminum, among other metals. The size of the targets 24, 124, 224 and detectors 28, 128, and 228 may vary depending upon the requirements of the installation. Targets 24, 124, 224 and detectors 28, 128, and 228 may range in outside dimension from about 0.25 inches to about 12 inches, but are typically, between about 2 and 6 inches in outside dimension, for example, about 4 inches in diameter or width.

In one aspect of the invention, two or more relative positions (for example, X and Y deviations from laser beam 20/120/220 shown in FIGS. 2, 7, and 8) can be determined. The two or more relative positions or readings may be determined for two or more orientations of target adapter 140, 240. For example, as shown in FIG. 6, target adapter 140 may be rotated in target 124, as indicated, for example, by arrow 170, to provide two or more relative positions of the centerline, or target feature, 150 relative to laser beam 120, that is, to “sweep” centerline 150. This procedure or “sweeping” may be repeated for other locations 126 of targets 124 to establish one or more baseline positions or for comparison to one or more predetermined baseline positions, for example, the baseline positions may be established at initial installation of the equipment on foundation 114. In another aspect, as shown in FIGS. 7 and 8, target adapter 240 may be mounted and then repositioned on target 224, and then may be repeated for other locations 126 of targets 224, to establish one or more baseline positions or for comparison to one or more predetermined baseline positions, for example, the baseline positions may be established at initial installation of the equipment on foundation 114. When two or more relative positions are obtained, the positions may be averaged, for example, to obtain an average of two or more relative positions of centerline 150 to laser beam 120 at location 126, or two or more positions X and Y shown in FIGS. 7 and 8. The positions are typically recorded to provide a historical record.

According to one aspect of the invention, one or more targets 124, 224 may be provided and sequentially mounted and unmounted to foundation plates 117, 227 to detect the deflection at each location 126. However, according to another aspect of the invention, multiple targets 124, 224 may be provided and each target 124, 224 may be mounted to a foundation plate 117.227. For example, a target 124, 224 may be uniquely matched to a foundation plate 117, 227. For instance, in order to minimize or eliminate variability due to the target 124, 224 used with each foundation plate 117, 217, in one aspect, in order to enhance the accuracy and repeatability of the measured deflections, at least some of the targets 124, 224 may be uniquely matched with respective foundation plates 117, 224. In one aspect, targets 124, 224 and foundation plates 117, 217 may each be identified by indicia, for example, numbers, letters, symbols, or a combination thereof, that uniquely associates each target 124, 224 with a foundation plate 117, 217. Accordingly, each target 124, 224 may be uniquely mounted in the same foundation plate 117, 217 on a given foundation 114.

In one aspect, with respect to the embodiment shown in FIG. 5, a set of ten (10) targets 124, 224 may be uniquely associated with the ten (10) foundation plates 117, 217 mounted on one side of the centerline 113 on foundation 114. This set of ten (10) targets 124, 224 and foundation plates 117, 217 may be used according to aspects of the invention on either side of foundation 114. In another aspect, a set of twenty (20) targets 124, 224 may be uniquely associated with the twenty (20) foundation plates 117, 217 mounted on both side of the centerline 113 on foundation 114. According to aspects of the invention, three or more targets 124, 224 and foundation plates 117, 217 may be provided.

In another aspect of the invention, targets 124, 224 and foundation plates 117, 217 may be configured to engage in only one predetermined orientation, for example, with the use one or more dowel pins, keys, or other structures. For example, as shown in FIG. 6, either foundation plate 117, 217 or mounting plate 144 of target 124, 224 may include an aperture, slot, or keyway 162 and a complementary projection or key 164 to ensure the desired orientation of target 124, 224 on foundation plate 117, 217. Though in one aspect, as shown in FIG. 6, keyway 62 and key 164 may permit the orientation of target 124, 224 to be reversible, that is, target 124, 224 may be positioned in the orientation shown or in an orientation rotated 180 degrees from that shown, in one aspect, one or more structures, for example, dowel pins and dowel pin holes, may be provided to limit the orientation of target 124, 224 on plate 117, 217 to one unique orientation.

According to aspects of the invention, a method is provided for determining deflection of an equipment foundation, the method including or comprising the following steps: positioning at least one target 24, 124, 224 above a surface 15, 115 of a foundation 14, 114, the at least one target 24, 124, 224 is coupled to the foundation 14, 114, the at least one target 24, 124, 224 is located at a location 26, 126 on the foundation 14, 114, and the at least one target 24, 124 has a target feature 30, 150, 250X, 250Y; directing a beam of electromagnetic radiation 20, 120, 220, for example, a laser beam, above the surface 15, 115 of the foundation 14, 114 to be monitored wherein the beam 20, 120, 220 passes in the vicinity of the target feature 30, 150, 250X, 250Y of at least one target 24, 124, 224; detecting a position of the target feature 30, 150, 250X, 250Y of at least one target 24, 124, 224 relative to a position of the beam of electromagnetic radiation 20, 120, 220 at the location 26, 126 of the at least one target 24, 124, 224; and comparing the detected position with a predetermined position of the target feature 30, 150, 250X, 250Y to determine a deflection of the foundation 14, 114 at the location 26, 126 of at least one target 24, 124, 224.

As discussed above, according to one aspect, the positioning of the targets 24, 124, 224 may be practiced by mounting a plurality of foundation plates 17, 117, 217 to the surface 15, 115 of foundation 14, 114, for example, with mechanical fasteners and/or grout. The foundation plates 17, 117, 217 may be strategically positioned near or adjacent to the equipment mounted on the foundation 14, 114, for example, near or adjacent to supports of the equipment, such as, bearing supports. Targets 24, 124, 224 may be uniquely matched to foundation plates 17, 117, 217 to minimize or prevent the target mounting contributing to deviations in the deflections determined. According to aspects of the invention, the targets 24, 124, 224 being “coupled” to the foundation 14, 114 may mean that targets 24, 124, 224 are mounted to foundation 14, 114 whereby any deflection of foundation 14, 114 will be reflected by corresponding deflection by targets 24, 124, 224. For example, in one aspect, coupled may mean “mounted” or “rigidly mounted” to foundation 14, 114. In addition, passing beam 20, 120, 220 “in the vicinity” of the target feature 30, 150, 250X, 250Y of the target 24, 124, 224 may mean that the beam 20, 120, 220 is directed sufficiently near target feature 30, 150, 250X, 250Y whereby a laser detector 28, 128, 228 may detect a difference in location of the target feature 30, 150, 250X, 250Y relative to the position of the beam 20, 120, 220 at the location 26, 126 of the target 24, 124, 224. A beam 20, 120, 224 in the vicinity of target feature 30, 150, 250X, 250Y may also be co-incident with target feature 30, 150, or, in some cases, pass through or strike target feature 30, 150.

According to aspects of the invention, detecting a position of the target feature 30, 150, 250X, 250Y of the target 24, 124, 224 relative to a position of the laser beam 20, 120, 220 may be practiced by any conventional means. However, as discussed above, the detection of this position may be practiced using a detector 28, 128, 228 physically associated with target feature 30, 150, 250X, 250Y, for example, physically positioned or mounted to target 24, 124, 224 whereby the detection of the position of the laser beam 20, 120, 220 at the location 26, 126 of the target 24, 124, 224 determines the relative position of the target feature 30, 150, 250X, 250Y.

Comparing the detected position with a predetermined position of the target feature 30, 150, 250X, 250Y may also be practiced by conventional means. For example, manually by a technician detecting and/or recording the detected position and manually or mentally calculating any change in the location of target feature 30, 150, 250X, 250Y, or recording the detected position for later comparison to one or more previously recorded target feature positions. Comparing the detected position with a predetermined position may also be practiced automatedly, for example, employing an arithmetic processor, such as, a data acquisition system, personal computer, laptop, or palm-size device. In one aspect, detector 28, 128, 228 may have storage and processor capability where the comparison may be practiced by laser detector 28, 128, 228. The results of the comparison may be stored for immediate or future retrieval, for example, on one of the devices mentioned above or on a display or printer. In one aspect, the detector 28, 128, 228 may communicate by wire or wirelessly with a remote receiver having data storage, data processing, and data output capabilities, for example, via local or wide area wireless network. The comparing may also be practiced remotely via communication over the Internet.

In one aspect, the invention may be practiced as quickly as possible to avoid error due to laser beam “drift.” Due to the fine differences in location being detected, for example, aspects of the invention may detect differences between the location of the target feature 30, 150, 250X, 250Y and the laser beam 20, 120, 220 of +/−0.0005 inches, any deviation in the position of the laser beam 20, 120, 220 can affect the accuracy of the readings. However, due to inherent fluctuations in beam source 18, 118 performance or detector 22, 122 performance, or detector 28, 128, 228 performance with time, it may be important to expedite the practicing of aspects of the invention to minimize or prevent the effects of laser beam drift. For example, in some aspects of the invention, the measurement of the readings, for example, after initial set up of the laser source 18, 118, laser sensor 22, 122, and one or more targets 24, 124, 224, may be practiced to completion in 10 minutes or less, or even 5 minutes or less. Should laser “drift” be addressed, for example, minimized or eliminated, aspects of the invention need not be expedited.

With respect to the system 110 illustrated in FIG. 4, according to one aspect of the invention, first, a plurality of targets 24, 124, 224 are mounted to the surface 115 of foundation 114, for example, to previously mounted foundation plates 17, 117, 217 positioned at predetermined locations along the length of foundation 114. Targets 24, 124, 224 are typically mounted in a straight line upon the surface 115. In order to facilitate this discussion, only the arrangement of apparatus 16 positioned on the near side of foundation 114 in FIG. 4 is discussed. A similar procedure may apply to the mounting and use of apparatus 116 positioned on the far side of foundation 114. Again, according to aspects of the invention, at least 3 targets 24, 124, 224 may be mounted to foundation 114.

Then, laser source 118 may be mounted in the left-most target 124, 224 shown in FIGS. 4 and laser detector 122 may be mounted in the right-most target 124, 224 shown in FIGS. 4. The mounting of laser source 118 and laser detector 122 may be practiced as discussed above. In the aspect shown in FIG. 4, the extreme left-most and right-most targets 124 are used to mount laser source 118 and laser detector 122; however, according to aspects of the invention, any two targets 124, 224 may be used to mount laser source 118 and laser detector 122. The activation of laser source 118 produces the laser beam 120, 220, which may or may not be visible to the human eye. The activation of laser detector 122 may be used to confirm the presence of laser beam 120, 220 and also to confirm the position of laser beam 120, 220. With the beam 120, 220 established, according to aspects of the invention, detector 128, 228 is inserted into a first target 124, 224, for example, as shown FIGS. 6-8, target adapter 140, 240 having laser sensor 142, 242 may be inserted into target 124, 224 where laser beam 120, 220 is detected by laser sensor 142, 242. The position of the target feature 30, 150, 250X, 250Y, for example, the centerline 150 of the bore 148 of target 124, is determined relative to the position of laser beam 120, 220 at the location 126 of target 124, 224. At least one, but typically, two or more relative positions, or “readings,” of target feature 30, 150, 250X, 250Y may be detected for each target 124, 224, for example, each target 124 may be “swept” to obtain a plurality of positions or readings, which may be averaged. This process may be repeated for each of the targets 124, 224 at their locations 126 on the near side of foundation 114, and may be repeated for the targets 124, 224 on the far side of foundation 114.

After completing a detection of the position of one or more target features, for example, taking readings of the position of the one or more target features 30, 150, 250X, 250Y, detector 128 may be removed and the position of laser beam 120, 220 checked by detector 122 to determine whether any laser “drift” has occurred. This confirmation of the position of laser beam 120, 220 may be practiced at any time during the process, but is preferably checked at least at the end of the process to determine whether any laser drift has occurred. If laser drift has occurred, the laser drift may be determined and recorded. The investigation can be repeated with the new laser beam 120, 220 position, or the drift of the laser beam 120, 220 can be used to adjust the magnitudes of the distances detected. In one aspect of the invention, after obtaining a complete set of positions from a set of targets 124, for example, on one side of foundation 114, the position of laser source 118 and the position of laser detector 122 may be reversed and a second set of positions or readings obtained for the reversed laser. These two sets of laser readings can be used to provide even more enhanced determination of the positions of target features 30, 150, 250X, 250Y. Obtaining a second, “reverse” set of readings can be useful when the equipment and foundation 114 are relatively long, for example, a foundation greater than about 75 feet in length, and the source 118 may be more susceptible to drift, or where conditions are otherwise adverse to laser stability.

The detection of movement of target features 30, 150, 250X, and/of 250Y can be used as an indication of not only the relative movement of foundation 14, but also as a means for determining the relative positions of the components of equipment 12, for example, the relative positions of the bearing supports of, for example, a turbine generator. The relative position of the equipment components can be used as a basis for analyzing the performance of the equipment or as a basis for investigating any variation in optimum performance, for example, as a means of “trouble shooting” variation in equipment performance. The detected movements or positions may also be used to vary the operation or position of the equipment component or components to accommodate readings that are “out of spec.” For example, the readings may be used to support equipment adjustment, realignment, or, if necessary, replacement.

Aspects of the present invention provide apparatus and methods for determining the deflection of a foundation that supports a piece of equipment, for example, a motor, in order to determine the relative position of components of the equipment. Unlike prior art methods that are typically limited to detecting deflection in a single dimension, specifically, vertical deflection, aspects of the present invention may be used to detect deflection in one or more dimensions, specifically, vertical deflection and/or horizontal deflection. Aspects of the invention can be provided to determine the deflection of foundations that support turbines, for example, steam turbine-generators, but aspects of the invention can also be applied to any piece of equipment, larger or small, for which foundation deflection is a concern. This equipment includes, but is not limited to, turbines, motors, generators, engines, transmissions, machines, machine tools, bridges, and buildings, among others. As will be appreciated by those skilled in the art, features, characteristics, and/or advantages of the various aspects described herein, may be applied and/or extended to any embodiment (for example, applied and/or extended to any portion thereof).

Although several aspects of the present invention have been depicted and described in detail herein, it will be apparent to those skilled in the relevant art that various modifications, additions, substitutions, and the like can be made without departing from the spirit of the invention and these are therefore considered to be within the scope of the invention as defined in the following claims.

1. A method for determining deflection of an equipment foundation, the method comprising:
positioning at least one target above a surface of a foundation, the at least one target coupled to the foundation, the at least one target located at a location on the foundation, and the at least one target having a target feature;
directing a beam of electromagnetic radiation above the surface of the foundation to be monitored wherein the beam passes in the vicinity of the target feature of the at least one target;
detecting a position of the target feature of the at least one target relative to a position of the beam of electromagnetic radiation at the location of the at least one target; and
comparing the detected position with a predetermined position of the target feature to determine a deflection of the foundation at the location of the at least one target.

2. The method as recited in claim 1, wherein positioning at least one target comprises positioning a plurality of targets above the surface of the foundation, each of the plurality of targets located at a location on the foundation and each of the targets having a target feature in a vicinity of the beam of electromagnetic radiation at the location on the foundation.

3. The method as recited in claim 1, wherein the beam of electromagnetic radiation comprises a laser beam.

4. The method as recited in claim 1, wherein the target comprises a circular bore and wherein the target feature comprises a feature of the circular bore.

5. The method as recited in claim 4, wherein the target feature comprises a centerline of the circular bore.

6. The method as recited in claim 1, wherein detecting a position of the target feature comprises positioning a beam detector in a path of the beam.

7. The method as recited in claim 4, wherein detecting a position of the target feature comprises mounting a detector on a target adapter and mounting the target adapter within the bore of the target wherein the detector is positioned to detect the beam.

8. The method as recited in claim 7, wherein detecting a position of the target feature further comprises detecting a first position of the target feature with the target adapter in a first position within the bore of the target and then rotating the target adapter within the bore of the target to a second position and detecting a second position of the target feature.

9. An apparatus for determining deflection of an equipment foundation, the apparatus comprising:
an electromagnetic radiation source positioned to direct a beam of electromagnetic radiation above a surface of a foundation to be monitored;
at least one target positioned above the surface of the foundation, the at least one target located at a location on the foundation and having a target feature positioned in a vicinity of the beam of electromagnetic radiation at the location;
a detector adapted to detect a position of the target feature of the target relative to a position of the beam of electromagnetic radiation at the location; and
means for comparing the detected position with a predetermined position to determine a deflection of the foundation at the location.

10. The apparatus as recited in claims 9, herein the apparatus further comprises an electromagnetic radiation detector positioned to detect the beam of electromagnetic radiation from the source.

11. The apparatus as recited in claim 9, wherein the at least one target comprises a plurality of targets positioned above the surface of the foundation, each of the plurality of targets located at a location on the foundation and each of the targets having a target feature in a vicinity of the beam of electromagnetic radiation at the location on the foundation.

12. The method ad recited in claim 9, wherein the beam of electromagnetic radiation comprises a laser beam.

13. The apparatus as recited in claim 9, wherein the target comprises a circular bore and wherein the target feature comprises a feature of the circular bore.

14. The apparatus as recited in claim 13, wherein the target feature comprises a centerline of the circular bore.

15. The apparatus as recited in claim 13, wherein the detector comprises a detector mounted on a target adapter mountable in the bore of the target wherein the detector is positioned to detect the beam.

16. The apparatus as recited in claim 15, wherein the target adapter is rotatably mounted within the bore of the target and wherein the detector rotates with the target adapter to a plurality of positions to detect a plurality of positions of the target feature.

17. An apparatus for determining deflection of a turbine foundation, the apparatus comprising:
a laser beam source positioned to direct a laser beam above a surface of the turbine foundation to be monitored;
a plurality of targets positioned above the surface of the foundation, each of the plurality of targets located at a location on the foundation and having a target feature positioned in a vicinity of the position of the laser beam at the location;
a detector adapted to detect a position of the target feature of each of the plurality of targets relative to a position of the laser beam at the location; and
means for comparing the detected position of each of the target features of each of the targets with a predetermined position of the target features at the location of each of the targets to determine changes in the position of each of the target features at each location to determine deflection of the foundation at each location.

18. The apparatus as recited in claim 17, further comprising a laser detector positioned to detect the laser beam emitted from the laser source.

19. The apparatus as recited in claim 17, further comprising a plurality of foundation plates mounted to the surface of the foundation, each of the plurality of foundation plates adapted to receive one of the plurality of targets.

20. The apparatus as recited in claim 17, wherein the each of the plurality of targets comprises a circular bore, wherein the target feature of each of the plurality of targets comprises a centerline of the circular bore, and wherein the detector comprises a detector mounted on a target adapter mountable in the circular bore of each of the plurality of the targets wherein the detector is positioned to detect the beam.

21. The method as recited in claim 1, wherein the target comprises a plurality surfaces and the target feature comprises at least one of the plurality of surfaces of the target.

22. The method as recited in claim 21, wherein the target feature comprises two of the plurality of surfaces of the target

23. The method as recited in claim 21, wherein detecting a position of the target feature comprises mounting a detector on a target adapter and mounting the target adapter upon the at least one of the plurality of surfaces of the target wherein the detector is positioned to detect the beam.

24. The method as recited in claim 23, wherein detecting a position of the target feature further comprises detecting a position of a first target feature with the target adapter in a first position upon the at least one of the plurality of surfaces and then repositioning the target adapter upon the at least one of the plurality of surfaces to a second position and detecting a position of a second target feature.

25. The apparatus as recited in claim 9, wherein the target comprises a plurality surfaces and the target feature comprises at least one of the plurality of surfaces of the target.

26. The apparatus as recited in claim 25, wherein the target feature comprises two of the plurality of surfaces of the target

27. The apparatus as recited in claim 25, wherein the detector comprises a detector mounted on a target adapter mountable upon the at least one of the plurality of surfaces of the target wherein the detector is positioned to detect the beam.

28. The apparatus as recited in claim 26, wherein the target adapter is mountable upon the target in a plurality of orientations, and wherein, when the target adapter is mounted to the target in a first orientation of the plurality of orientations, the detector is adapted to detect a position of a first surface of the two surfaces, and wherein, when the target adapter is mounted upon the target in a second orientation of the plurality of orientations, different from the first orientation, the detector is adapted to detect a position of a second surface of the two surfaces.

29. The apparatus as recited in claim 17, wherein the each of the plurality of targets comprises a body having a first surface and a second surface substantially perpendicular to the first surface, and wherein the target feature of each of the plurality of targets comprises the first surface and the second surface, and wherein the detector comprises a detector mounted on a target adapter selectively mountable on one of the first surface and the second surface of each of the plurality of the targets wherein the detector is positioned to detect the beam.
